(19) United States
(12) Patent Application Publication
(10) Pub. No.: US 2025/0283566 A1
(43) Pub. Date: Sep. 11, 2025

(54) FITTINGS FOR JOINING LENGTHS OF PIPE AND PIPE ASSEMBLY FORMED USING SAME

(71) Applicant: Trinity Products, LLC, O'Fallon, MO (US)

(72) Inventors: Andrew Joseph Griggs, II, St. Peters, MO (US); Timothy Kevin Ransom, Wentzville, MO (US); Anthony Lee Baker, JR., St. Charles, MO (US); Robert L. Griggs, St. Charles, MO (US); Nicholas Lee Johnson, Eureka, MO (US); Luke Crump, O'Fallon, MO (US)

(73) Assignee: Trinity Products, LLC, O'Fallon, MO (US)

(21) Appl. No.: 19/072,175

(22) Filed: Mar. 6, 2025

Related U.S. Application Data
(60) Provisional application No. 63/562,622, filed on Mar. 7, 2024.

(51) Int. Cl. F16L 37/091

(52) U.S. Cl. CPC F16L 37/091

(57) ABSTRACT

A pipe assembly is provided, the pipe assembly comprising: a male fitting, comprising: an annular portion of pipe having a radially inner side and a radially outer side; at least one circumferentially-discontinuous section of teeth; and at least one circumferentially-discontinuous land; a female fitting, comprising: an annular portion of pipe having a radially inner side and a radially outer side; at least one circumferentially-discontinuous section of teeth; and at least one circumferentially-discontinuous groove.

### CROSS-REFERENCE TO RELATED APPLICATIONS

This application claims priority from U.S. Provisional Patent Application No. 63/562,622 filed on Mar. 7, 2024, which is incorporated by reference herein in its entirety.

### BACKGROUND

Creating a pipeline, whether horizontally or vertically, and whether underground or above ground, one typically assembles consecutive lengths of pipe one after the other.

Traditionally, individual lengths of pipe used in forming a pipeline are arranged in a line, end-to-end, with each being welded to the next as individual lengths of pipe are added to the pipeline. However, welding the individual lengths of pipe to one another is a time-consuming process involving additional danger, high heat, skilled welding personnel, time to allow welds to cool, and possible imperfections in the finished product.

Accordingly, what is needed is a pipe connection that requires less time and work to assemble, while being able to withstand the compressive and bending stresses that the pipes will experience both during installation and operation in the field.

### SUMMARY

In one aspect, a pipe assembly is provided, the pipe assembly comprising: a male fitting, comprising: an annular portion of pipe having a radially inner side and a radially outer side; at least one circumferentially-discontinuous section of teeth; and at least one circumferentially-discontinuous land; a female fitting, comprising: an annular portion of pipe having a radially inner side and a radially outer side; at least one circumferentially-discontinuous section of teeth; and at least one circumferentially-discontinuous groove.

### BRIEF DESCRIPTION OF THE FIGURES

The accompanying figures, which are incorporated in and constitute a part of the specification, illustrate various example embodiments, and are used merely to illustrate various example embodiments. In the figures, like elements bear like reference numerals.

FIG. 1A illustrates a perspective view of a pipe assembly 100, including a female fitting 102 and a male fitting 104.

FIG. 1B illustrates a sectional view of a pipe assembly 100, including a female fitting 102 and a male fitting 104.

### DETAILED DESCRIPTION

As used throughout this application, the radial direction refers to direction R as illustrated in the drawings. Radially outer or radially outwardly refers to the direction R as the radius is increased, whereas radially inner or radially inwardly refers to the direction R as the radius is decreased. As used throughout this application, the axial direction refers to that extending along or parallel to direction A. The axial direction A is intended to extend along the longitudinal length of a pipe assembly. As used throughout this application, the circumferential direction refers to direction C, which extends about the circumference of the pipe assembly in a plane orthogonal to the axial direction A, and parallel to the radial direction R.

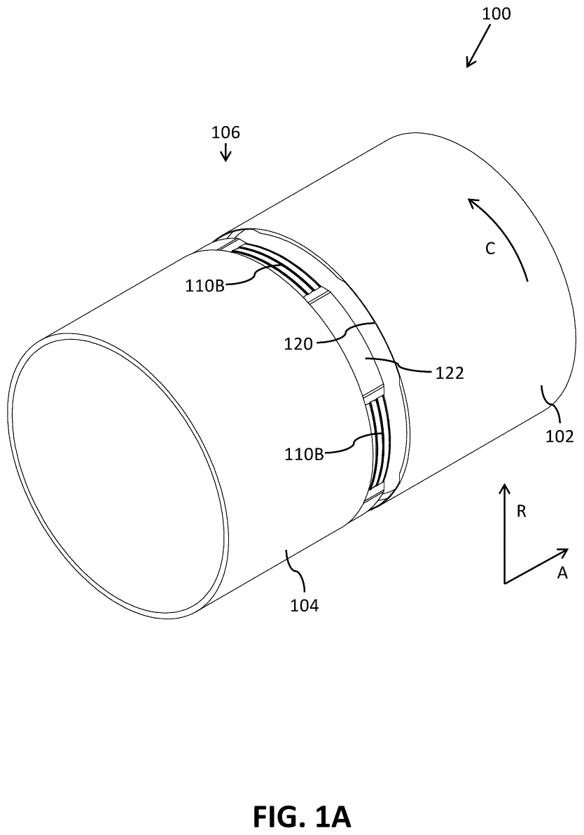

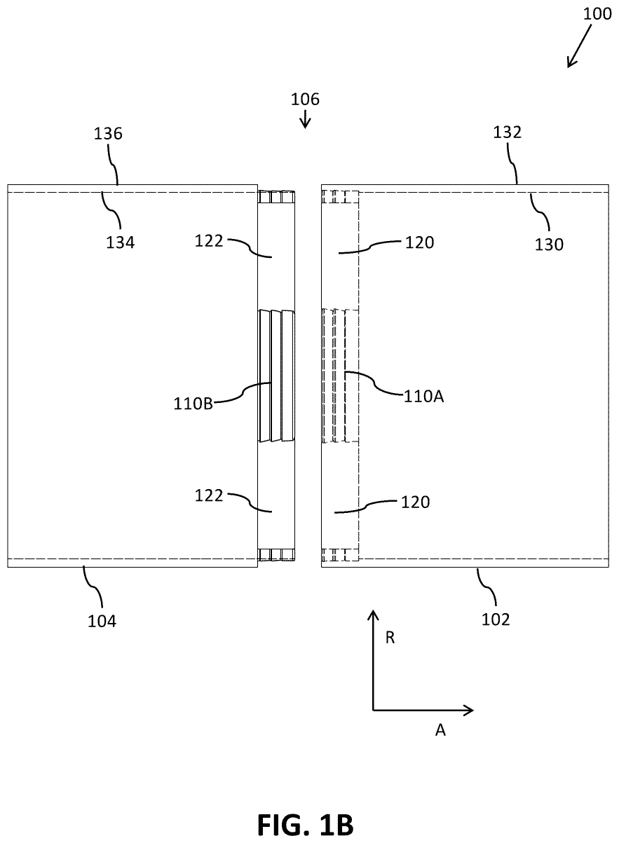

FIGS. 1A and 1B illustrate a pipe assembly 100, including a female fitting 102 and a male fitting 104 at a junction 106.

Female fitting 102 may include an annular portion of pipe having a radially inner side 130 and a radially outer side 132. Radially inner side 130 of female fitting 102 includes teeth 110A and grooves 120 at its distal end.

Male fitting 104 may include an annular portion of pipe having a radially inner side 134 and a radially outer side 136. Radially outer side 136 of male fitting 104 includes circumferentially-discontinuous sections of teeth 110B and lands 122 at its distal end, corresponding to those of female fitting 102, as will be further described below.

Female fitting 102 may include at least one circumferentially-discontinuous section of teeth 110A. Female fitting 102 may include at least one circumferentially-discontinuous groove 120. Female fitting 102 may include a plurality of circumferentially-discontinuous sections of teeth 110A alternating with a plurality of circumferentially-discontinuous grooves 120. In one aspect, female fitting 102 includes four circumferentially-discontinuous sections of teeth 110A equally distributed about the circumference of female fitting 102, centered 90 degrees apart from one another, and four circumferentially-discontinuous grooves 120 equally distributed about the circumference of female fitting 102, centered 90 degrees apart from one another, wherein each of the grooves 120 are oriented between two sections of teeth 110A and wherein each section of teeth 110A are oriented between two grooves 120. In another aspect, female fitting 102 includes three circumferentially-discontinuous sections of teeth 110A equally distributed about the circumference of female fitting 102, centered 120 degrees apart from one another, and three circumferentially-discontinuous grooves 120 equally distributed about the circumference of female fitting 102, centered 120 degrees apart from one another, wherein each of the grooves 120 are oriented between two sections of teeth 110A and wherein each section of teeth 110A are oriented between two grooves 120. In another aspect, female fitting 102 includes three, four, or five circumferentially-discontinuous sections of teeth 110A equally distributed about the circumference of female fitting 102, and three, four, or five circumferentially-discontinuous grooves 120 equally distributed about the circumference of female fitting 102, wherein each of the grooves 120 are oriented between two sections of teeth 110A and wherein each section of teeth 110A are oriented between two grooves 120.

Male fitting 104 may include at least one circumferentially-discontinuous section of teeth 110B. Male fitting 104 may include at least one circumferentially-discontinuous land 122. Male fitting 104 may include a plurality of circumferentially-discontinuous sections of teeth 110B alternating with a plurality of circumferentially-discontinuous lands 122. In one aspect, male fitting 104 includes four circumferentially-discontinuous sections of teeth 110B equally distributed about the circumference of male fitting 104, centered 90 degrees apart from one another, and four circumferentially-discontinuous lands 122 equally distributed about the circumference of male fitting 104, centered 90 degrees apart from one another, wherein each of the lands 122 are oriented between two sections of teeth 110B and wherein each section of teeth 110B are oriented between two lands 122. In another aspect, male fitting 104 includes three circumferentially-discontinuous sections of teeth 110B equally distributed about the circumference of male fitting 104, centered 120 degrees apart from one another, and three circumferentially-discontinuous lands 122 equally distributed about the circumference of male fitting 104, centered 120 degrees apart from one another, wherein each of the lands 122 are oriented between two sections of teeth 110B and wherein each section of teeth 110B are oriented between two lands 122. In another aspect, male fitting 104 includes three, four, or five circumferentially-discontinuous sections of teeth 110B equally distributed about the circumference of male fitting 104, and three, four, or five circumferentially-discontinuous lands 122 equally distributed about the circumference of male fitting 104, wherein each of the lands 122 are oriented between two sections of teeth 110B and wherein each section of teeth 110B are oriented between two lands 122.

Regardless of the number of sections of teeth 110A, 110B, grooves 120, and lands 122, female fitting 102 and male fitting 104 have the same number of sections of teeth 110A, 110B, and the same number of grooves 120 and lands 122. For example, if female fitting 102 includes four sections of teeth 110A, then male fitting 104 includes four sections of teeth 110B, and if female fitting 102 includes three grooves 120, then male fitting 104 includes three lands 122. Stated simply, each section of teeth 110A in assembly 100 has a corresponding section of teeth 110B, and each groove 120 in assembly 100 has a corresponding land 122.

At least one of female fitting 102 and male fitting 104 may be formed independently of a length of pipe, and may welded or otherwise mechanically fixed to the length of pipe at a proximal end of female fitting 102 and/or male fitting 104. This welding or mechanical attachment of female fitting 102 and/or male fitting 104 to a length of pipe may be performed away from the site of installation of the pipe, or on the site of installation of the pipe.

Alternatively, at least one of female fitting 102 and male fitting 104 may be machined directly into the ends of a length of pipe. The machining of female fitting 102 and male fitting 104 may be performed using known machining techniques.

While the drawings focus on the fittings fixing lengths of pipe to one another, rather than the lengths of pipe themselves, it is understood that the fittings are oriented at the ends of a length of pipe. In practice, a single length of pipe may include female fitting 102 at a first end, and male fitting 104 at a second end. In this manner, a series of like lengths of pipe may be fit together, with the female end of a first length of pipe engaging the male end of a second length of pipe, while the male end of the first length of pipe engages the female end of a third length of pipe.

Alternatively, a single length of pipe may include female fitting 102 at both its first ends and second ends, or may include male fitting 104 at both its first ends and second ends. In this manner, the independent lengths of pipe would be either “male” lengths (with male fitting 104 at each end), or “female” lengths (with female fitting 102 at each end). Assembling a pipeline using these lengths of pipe would require alternating between male lengths and female lengths during assembly of the pipeline.

Female fitting 102 and male fitting 104 may be made of any of a variety of materials, including without limitation, a metal (such as steel), an alloy, a polymer, a composite, and the like. In order for female fitting 102 and male fitting 104 to deflect enough relative to one another during the press-fitting of the two together, the material may need appropriate elastic qualities.

Lengths of pipe used in association with female fitting 102 and male fitting 104 may include any of a variety of lengths convenient for manufacture, transport, and assembly.

Diameters of lengths of pipe used in association with female fitting 102 and male fitting 104, and thus the diameters of female fitting 102 and male fitting 104, can be any of a variety of diameters. For example, the pipe and fittings may have outer diameters between about 6 in. (15 cm) and 127 in. (323 cm). The pipe and fittings may have outer diameters outside of this range as well.

Female fitting 102 includes teeth 110A. Male fitting 104 includes teeth 110B. Teeth 110A and 110B are configured (i.e., sized and shaped) to engage one another upon insertion of male fitting 104 into female fitting 102 to prevent movement of female fitting 102 relative to male fitting 104 in axial direction A.

Teeth 110A and 110B may include at least one standard tooth extending circumferentially along the circumferentially-discontinuous sections of teeth 110A, 110B. The at least one standard tooth includes an engagement surface parallel to the radial direction R.

Teeth 110A and 110B may include at least one biased tooth extending circumferentially along the circumferentially-discontinuous sections of teeth 110A, 110B. The at least one biased tooth includes and engagement surface biased at an angle relative to the radial direction R. The angle may be any of a variety of angles, including for example, 22 degrees. The angle may be between 20 degrees and 24 degrees. The angle may be between 18 degrees and 26 degrees. The angle may be between 16 degrees and 28 degrees. The angle may be between 14 degrees and 30 degrees. The angle may be between 12 degrees and 32 degrees.

Assembly 100 may include two, three, or four teeth 110A and 110B. Assembly 100 may include an equal number of teeth 110A as teeth 110B in a given section of teeth.

The biased engagement surfaces may be biased toward the proximal direction of the corresponding female fitting 102 and male fitting 104. That is, the biased tooth of female fitting 102 is biased such that the biased engagement surface extends in the proximal direction of female fitting 102 as the engagement surface extends radially away from the body of female fitting 102. The biased tooth of male fitting 104 is biased such that the biased engagement surface extends in a proximal direction of male fitting 104 as the engagement surface extends radially away from the body of male fitting 104.

Female fitting 102 includes grooves 120. Male fitting 104 includes lands 122. Grooves 120 and lands 122 are configured (i.e., sized and shaped) to engage one another upon insertion of male fitting 104 into female fitting 102 to prevent rotation of female fitting 102 relative to male fitting 104 in circumferential direction C about an axis parallel to axial direction A. Lands 122 are sized, shaped, and spaced to fit into grooves 120, while grooves 120 are sized, shaped, and spaced to accept lands 122.

Grooves 120 may be machined into the thickenss of female fitting 102 from radially inner side 130. Lands 122 may be machined into the thickness of male fitting 104 from radially outer side 136. Teeth 110A may be machined into the thickenss of female fitting 102 from radially inner side 130. Teeth 110B may be machined into the thickness of male fitting 104 from radially outer side 136.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A pipe assembly, comprising:
a male fitting, comprising:
an annular portion of pipe having a radially inner side and a radially outer side;
at least one circumferentially-discontinuous section of teeth; and
at least one circumferentially-discontinuous land;
a female fitting, comprising:
an annular portion of pipe having a radially inner side and a radially outer side;
at least one circumferentially-discontinuous section of teeth; and
at least one circumferentially-discontinuous groove.

2. The pipe assembly of claim 1, wherein the male fitting and the female fitting include the same number of circumferentially-discontinuous sections of teeth.

3. The pipe assembly of claim 1, wherein the male fitting includes the same number of circumferentially-discontinuous lands as the female fitting includes circumferentially-discontinuous grooves.

4. The pipe assembly of claim 1, wherein the male fitting includes a section of teeth having at least one standard tooth extending circumferentially along the circumferentially-discontinuous section of teeth, wherein the standard tooth includes an engagement surface parallel to a radial direction of the pipe assembly.

5. The pipe assembly of claim 1, wherein the male fitting includes a section of teeth having at least one biased tooth extending circumferentially along the circumferentially-discontinous section of teeth, wherein the biased tooth includes an engagement surface biased at an angle relative to a radial direction of the pipe assembly.

6. The pipe assembly of claim 1, wherein the female fitting includes a section of teeth having at least one standard tooth extending circumferentially along the circumferentially-discontinuous section of teeth, wherein the standard tooth includes an engagement surface parallel to a radial direction of the pipe assembly.

7. The pipe assembly of claim 1, wherein the female fitting includes a section of teeth having at least one biased tooth extending circumferentially along the circumferentially-discontinuous section of teeth, wherein the biased tooth includes an engagement surface biased at an angle relative to a radial direction of the pipe assembly.

8. The pipe assembly of claim 1, wherein each male fitting circumferentially-discontinuous section of teeth engages each female fitting circumferentially-discontinuous section of teeth.

9. The pipe assembly of claim 1, wherein each male fitting circumferentially-discontinuous land engages each female fitting circumferentially-discontinuous groove.
